(19) United States
(12) Patent Application Publication
(10) Pub. No.: US 2017/0367927 A1
(43) Pub. Date: Dec. 28, 2017

(54) INTEGRATION OF THE AUTOMATED EXTERNAL DEFIBRILLATOR IN AUTOMOBILES TELEMATICS AND SMART HOME TECHNOLOGIES

(71) Applicant: Arturo Cervantes, El Paso, TX (US)

(72) Inventor: Arturo Cervantes, El Paso, TX (US)

(21) Appl. No.: 15/633,641

(22) Filed: Jun. 26, 2017

Related U.S. Application Data
(60) Provisional application No. 62/354,280, filed on Jun. 24, 2016.

(51) Int. Cl. A61H 31/00; G06F 19/00; B60W 40/08

(52) U.S. Cl. CPC A61H 31/005; G06F 19/3418; B60W 2040/0872

(57) ABSTRACT

An apparatus for providing improved access to an automated external defibrillator includes a computerized communication system providing access to a remote server device operated by an emergency responder, a power system providing power to the automated external defibrillator, and the automated external defibrillator in electronic communication with the communication system and the power system.

### CROSS REFERENCE TO RELATED APPLICATIONS

This disclosure claims the benefit of U.S. Provisional Application No. 62/354,280 filed on Jun. 24, 2016, which is hereby incorporated by reference.

### TECHNICAL FIELD

This disclosure is related to a system and method for integrating automated external defibrillators in automobiles equipped with telematics and homes equipped with the Internet and home monitoring systems.

### BACKGROUND

The statements in this section merely provide background information related to the present disclosure. Accordingly, such statements are not intended to constitute an admission of prior art.

Approximately 350,000 Americans lives are lost annually to sudden cardiac arrest with 88% of all SCAs in the United States occurring at home and public areas. Statistics from both the American Heart Association® and the U.S. Department of Health and Human Services confirmed more than 900 deaths to sudden cardiac arrest each day. Medical experts urge that access to an AED within the first critical four minutes after an SCA occurs saves lives. Residual outcomes for surviving SCA victims, with such access to an AED device, would include improving the quality of their life, especially for the aging population, while reducing the loss of the lives of 350,000 SCA victims dying annually. In reducing the loss of lives and improving the quality of life for survivors of SCA, it would reduce health care costs post SCA. This cost is approximately $100 billion in annual expense for U.S. businesses and consumers. These reductions would be positive business and social outcomes.

### SUMMARY

An apparatus for providing improved access to an automated external defibrillator includes a computerized communication system providing access to a remote server device operated by an emergency responder, a power system providing power to the automated external defibrillator, and the automated external defibrillator in electronic communication with the communication system and the power system.

### BRIEF DESCRIPTION OF THE DRAWINGS

One or more embodiments will now be described, by way of example, with reference to the accompanying drawings, in which:

FIG. 1 illustrates potential locations for AED installation/integration/accessibility in the automobile, in accordance with the present disclosure;

FIG. 2 illustrates an exemplary AED unit equipped with wireless communications, in accordance with the present disclosure;

FIG. 3 illustrates alternative exemplary paths of communications that can be established between an AED unit and a remote server, in accordance with the present disclosure;

FIG. 4 illustrates an exemplary AED unit installed to a dashboard of a vehicle, in accordance with the present disclosure;

FIG. 5 illustrates an exemplary process to establish a link to a remote server and take action based upon collected data, the process being initiated by an AED unit being removed from an AED chamber, in accordance with the present disclosure; and

FIG. 6 illustrates an exemplary AED unit stored in a home, in accordance with the present disclosure.

### DETAILED DESCRIPTION

A system and method integrating an automated external defibrillator (AED) medical system within a vehicle or home are disclosed. Connectivity in vehicle and homes has increased exponentially in recent years. Computing systems, smart phones, wireless hotspots, vehicle communications systems, etc. have greatly improved access to online systems available through the Internet or remote computing server systems. As a result, an opportunity to make available advanced medical systems within everyday environments of ordinary people exists. Whereas twenty years ago, a person having a Sudden Cardiac Arrest (SCA) would live or die depending upon whether an ambulance with trained paramedics arrived on the scene within a critical lifesaving time, AEDs have become commercially available that can be posted in schools, sports arenas, and other similar locations. Trained individuals, upon witnessing an SCA, can deploy these AED devices and save lives.

Self-contained portable AED devices have a number of limitations that can be solved by integrating AED devices into smart vehicles or smart homes equipped with telecommunications equipment capable of communicating wirelessly or otherwise with remote systems, people, or resources.

The outcome is the concept and technological innovation increasing the accessibility to an AED for the purpose of providing bystanders to render aid to a victim suffering from SCA. Such a system would enable integrating a customized AED in every automobile. This will reduce the time to reach an AED and aid to an SCA victim, thus substantially reducing the number of lives being lost during Sudden Cardiac Death (SCD). The customization of an AED designed for an automobile will also include interfacing capability (openAED) to those automobiles equipped with telematics technology. By installing an AED in every automobile it will provide access to an AED in public and private areas along with immediate notification to the 911 operator; first responders; and healthcare professionals.

The idea in integrating a customized AED designed to be installed in every home is for the purpose of providing immediate access to an AED to bystanders to render aid to a victim suffering from SCA. This alone will reduce the time for bystanders to aid a family member suffering an SCA. The current options for the family today, is provided by first responders through a 911 call averaging 8 minutes to respond. The customization of an AED designed for a home will also include interfacing capability (openAED) to those homes equipped with Smart Home Technology. By installing an AED in every home, it will provide access to any household member during SCA.

The basic integration of an AED to the automobile and another type of transportation involves installing and connecting the AED in an accessible and visible area in its own chamber embedded in the automobile. The AEDs will vary in types. The basic type AED can be installed and connected to the automobiles as a standalone unit with a backup power source. Other embodiments will include connectivity to the automobiles' Network Telecommunications Unit (NTU) having telematics capability and thus integrating the automobiles telematics capability and mobile connectivity. In terms of security, telecommunications companies are responsible for developing and maintaining comprehensive security policies, standards, and procedures. Exemplary telematics protocols are known in the art, reporting through business operations, with risk management personnel supporting global security operations. Such telematics systems provide all the wi-fi and Infotainment connectivity to perform any hands-free mobile talking, Internet local search, and parking management. Such technology is another provider to yield telematics type features and connectivity with precision is a location with value-add resources leveraging cloud base computing. These are all value-add features and benefits in the case of an emergency such as a case of SCA. However, it is in the critical minutes (4-6 minutes maximum) in which a bystander must have a working AED accessible for use, combined with the use of Cardio Pulmonary Resuscitation (CPR) as first responders make their way to the scene of the incident.

As it relates to SCAs occurring at home alongside the growing population of the retiring baby boomer, the risks are continuing to grow. The concept and technology of integrating an AED in a private home are to provide immediate access for a bystander. The basic integration of an AED to home involves a standalone portable unit for any bystander while 911 Responders are being contacted. Other models include interfacing and connecting the AED in an accessible and visible area or in its own chamber embedded in a central location. The AEDs will vary in types. More technologically sophisticated models will include connectivity to the homes communications infrastructure i.e. mobile healthcare monitoring systems; security response units; audio and video systems; and basic telephone and Internet services.

Over 932 deaths occur each day to SCA with approximately 792 occurring at home. If a home for the aging baby boomer is in a remote location, it implies a higher risk because home is where AED manufacturers have grown their customer base the least.

Growing incidences of cardiovascular diseases and disorders, combined with the aging of baby boomer population entering their 65th birthday since 2011, are contributing to the growth of the U.S. defibrillators market. Concurrently, operating expenses alongside market demands are forcing hospitals to consolidate their resources and physical presence in metropolitan areas as opposed to remote or rural areas. The aging population has the tendency to relocate to more remote areas for peace and quiet, yet medical facilities are relocating to metropolitan areas. This relocation factor reduces first-responder and emergency resources to the aging population. This remote living is especially concerning because these individuals depend on ease of accessibility and quick response for urgent medical attention. Retiring in rural areas for the aging boomers may not be a good option if these trends continue. This trend is an opportunity for medical device manufacturer marketing leaders to seize the trend by solving the issue using mobile health devices and technologies for the rural home, home health care, and retirement home facilities.

The design of both the automobile compartment to infuse the AED and the design of the AED to be installed and integrated will involve the partnership of both selected manufacturers with this invention in mind, in the test, and in the application. However, it based on existing interface connectors and IEEE standards.

Telematics is the combination of computer systems and networks, alongside with wireless telecommunications technologies, ostensibly with the goal of efficiently transmitting information over vast networks to improve a host of business functions, private services, and government-related public services. The popularization of consumer electronic products and the promotion of digital mobile devices have assisted telematics services in becoming viable and practicable. The global positioning system (GPS) is commonly used today in tracking vehicle locations for metrics collection and rendering aid as needed. It is a premise of an open architecture environment for telematics services based on international standards, that the AED will be integrated into automobiles, cargo trailers, buses, trains, and much other private and public transportation.

Similarly, the disclosed connected AED device can be used in a home equipped with communications/computerized technology or a smart home. These concepts and technology have been designed for the purpose of preventing SCD in and outside the home.

Open systems technology discussed herein is additionally useful so as to interface the AED to existing smart homes technology and solutions currently deployed. These include Philips telehealth; Lifeline; and healthmatics technologies. Other platforms from providers such as ADT's Home Alarm Systems include video surveillance, home automation, and medical alert. These products require either telephone lines, the Internet, and Wi-Fi connectivity, or Local Area Network (LAN) connectivity which will interface with GPS location technology, as described in the illustration above for the use of telematics.

The Food and Drug Administration (FDA) has approved AEDs for home use without a prescription by four medical device manufacturers in 2013. Homes are the least equipped with AEDs or AED despite FDA approvals. Despite awareness of defibrillation is the only effective treatment for sudden cardiac arrest plans for a solution fail to exist. Less than 34% of the United States has public access to an AED, and less than 15% of private facilities have an AED. With only 34% of public access to an AED, medical device manufacturing marketing leaders are leaving a 66% of the market unequipped. The results are similar for other consumers. The other consumers account for 85% of the U.S. market. Segments of this market are private facilities and homes do not own an AED.

The market demands safe and easy to use features, as well as emerging technologies in out-of-hospital markets. These features may be in concert with the boomer population which is more digitally centric. There are increasing trends toward installations of AEDs at workplaces by direct sales channels. No trends of AEDs home sales, installation, or training programs exist. This trend is a good opportunity for growth in the defibrillators market. With boomers more digitally centric, coupled with no product recalls since 2010, the opportunity for growth prevails.

Benefits of the disclosed system include connection of an AED to a reliable power source such as a vehicle battery or a home power system. Further, activation of the AED system can automatically trigger activation of a 911 system, automatic voice connection of the device to a remote on call doctor, and interface to a remote server that can apply diagnostic analysis to readings such as heartbeat sensors located on the AED. A heartbeat sensor can be employed within a vehicle, for example, monitoring a person in the passenger seat and automatically alerting the driver and activating the AED system based upon the monitored heartbeat. A remote service can, without contacting the driver or homeowner, perform diagnostics on the AED device tied to the smart vehicle or smart home to ensure that it is ready to use when needed. Vehicle to vehicle communications can be enabled, where one vehicle with sensors monitoring a heartbeat of the driver can contact a nearby vehicle with an integrated AED and a volunteer trained driver in the event of an SCA. Such a vehicle to vehicle system could enable the volunteer driver, for example, to command the vehicle with the victim inside to flash its lights and unlock its doors.

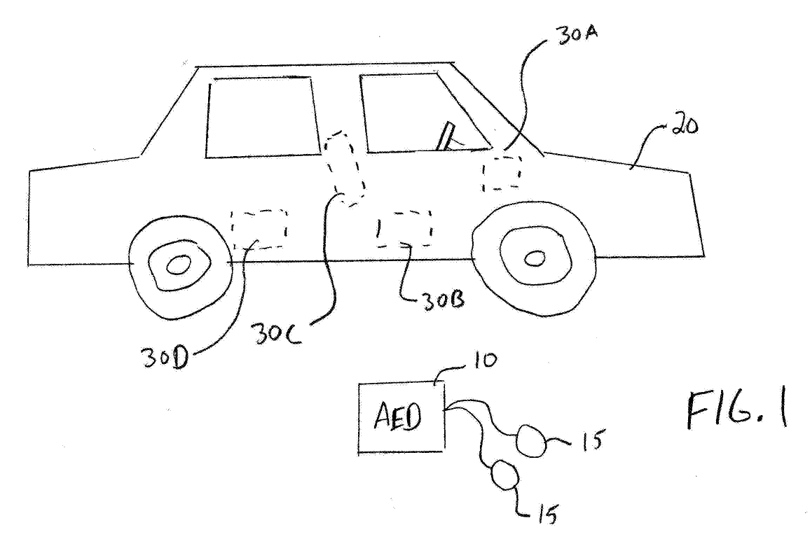

FIG. 1 illustrates potential locations for AED installation/integration/accessibility in the automobile. Vehicle 20 is illustrated including various locations for AED installation within the vehicle. AED 10 including electrode units 15 is illustrated. AED 10 can be stored and charged and/or receive power from a charging station or AED chamber in location 30A within an instrument panel or dashboard, within console location 30B between the front seats, within seat back 30C behind either the driver seat or the passenger seat, or within location 30D integrated within the rear seat. Seat back location 30C can include an exemplary heartbeat sensor to monitor a heartbeat of a passenger and activate the system based upon a monitored problem. Locations illustrated in vehicle 20 are exemplary, and can include other exemplary locations such as within a glove box, within a trunk, mounted to a roof pillar, or within a door panel. Other exemplary vehicles such as a motorcycle or a commercial truck can similarly include locations in which to store and provide power to AED 10. AED 10, upon an emergency, can be removed from any of the locations within the vehicle and employed to treat the person in medical distress.

Wireless means of communication between a vehicle and devices around or near a vehicle are widely known. For example, Bluetooth° technology can permit the AED 10 to communicate with systems of vehicle 20 and utilize computerized systems within the vehicle, for example, making use of cellular communication networks enabled by the vehicle or accessing additional processing power within vehicle 20, for example, to operate computerized processes for analyzing inputs from electrode units 15 to diagnose a status of the person being treated. In another embodiment, AED 10 can utilize cellular communication means to communicate directly with a remote server via wireless communication without accessing systems of vehicle 20.

In one embodiment, courtesy or public service vehicles could be operated by a city, with individuals trained in the use of AED devices. These vehicles could be similar to an ambulance with significantly lower training and operating costs, where a smart home alerting the disclosed system of an SCA could easily be dispatched by the system to the location of the alert.

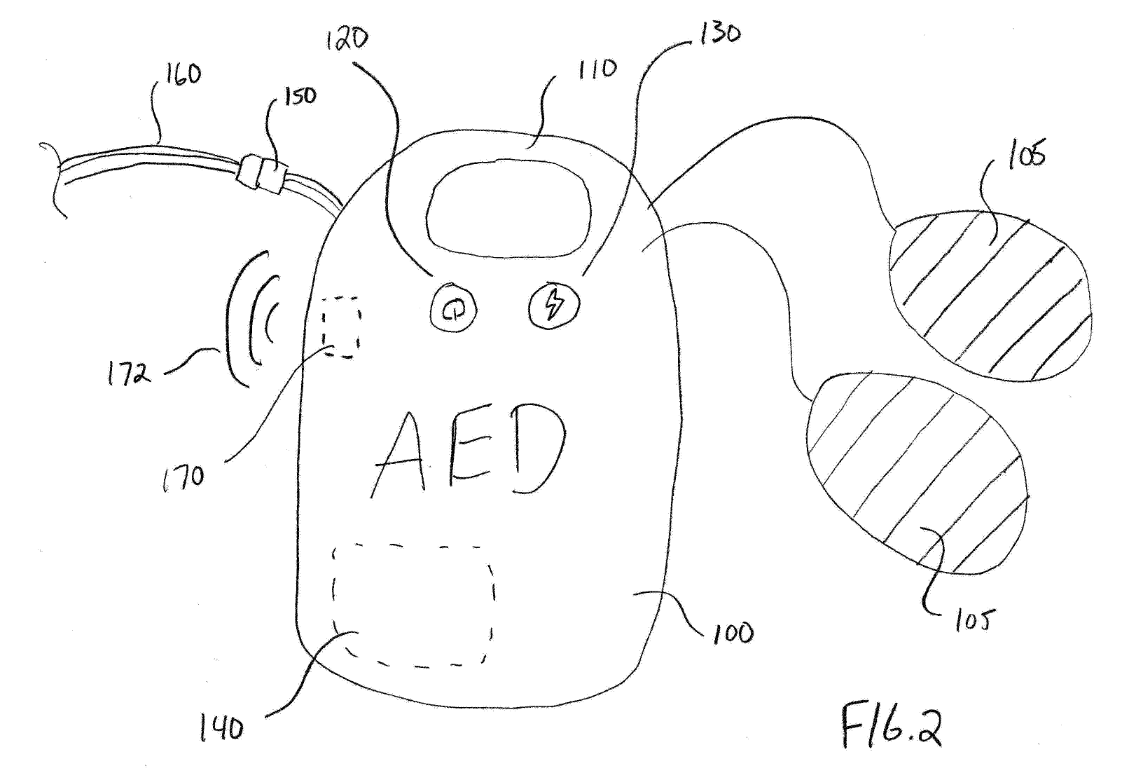

FIG. 2 illustrates an exemplary AED unit. AED units can take any number of forms, shapes, and sizes. Different functionality is possible within AED units, including applying therapeutic shocking of the person being treated, diagnostic electrocardiogram (EKG) readings, audio communication, visual communication including video playback of instructions on how to use the unit and/or coaching on how to perform cardiopulmonary resuscitation (CPR), location services including an ability to report a location of the emergency to an emergency responder, and other services relevant to such an emergency.

AED unit 100 of FIG. 2 is illustrated, including handle 110, electrode units 105 which can include both structures for providing a shock to the person being treated and sensors capable of monitoring vital signs such as a heartbeat, power button 120, and apply shock button 130. In some embodiments, the power button 120 and apply shock button 130 can be omitted, with the unit automatically being activated when removed from the vehicle or the AED chamber in which the unit charges and with the shock being applied when the unit senses that it has been correctly deployed to a person that needs shock treatment. AED unit 100 is illustrated including an optional internal battery 140, an optional power/information tether 160, and an optional internal cellular/wi-fi communications module 170. AED unit 100 requires electrical power to operate and needs a communication link to provide access to a remote server operated by an exemplary emergency responder. Such power can come through tether 160 or from battery 140. Such communication can be transmitted through tether 160 or as a wireless communication link 172 through module 170. In one embodiment, the AED unit 100 can use tether 160 for power and communication, and tether 160 can be equipped with a quick release fitting 150, such that if the AED unit 100 must be moved past a reach afforded by a length of tether 160, backup power and communication can be provided through battery 140 and module 170, respectively. AED unit 100 is a non-limiting example of an AED unit can be deployed with the disclosed systems and processes, and the disclosure is not intended to be limited to the provided exemplary embodiment. The AED unit can include a video screen or touch screen to facilitate a remote server providing instructions or calming communication with the person using the AED unit.

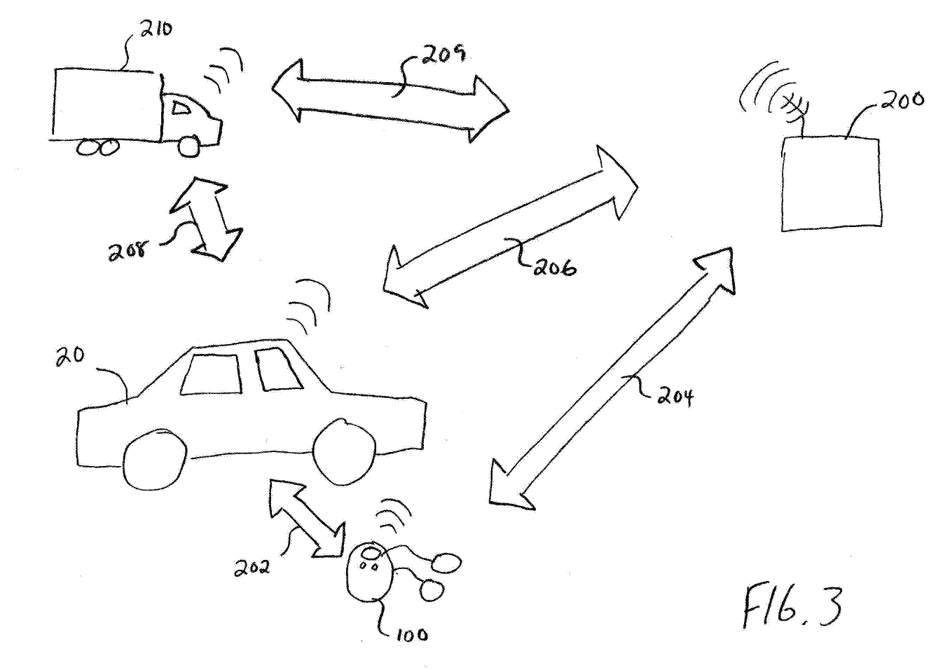

Communication between an AED unit and a remote server operated by an emergency responder can mean a great deal to the outcome for the person being treated. Multiple and redundant communication means can be beneficial to compensate for spotty or intermittent cellular communications. FIG. 3 illustrates alternative exemplary paths of communications that can be established between an AED unit and a remote server. AED unit 100, vehicle 20, remote vehicle 210, and remote server 200 are illustrated. AED unit 100 can communicate through path 202 to vehicle 20. Vehicle 20 can communicate directly with remote server 200 through path 206. In the case of intermittent or unreliable cellular communications through path 206, vehicle 20 can additionally or alternatively communicate directly with another nearby vehicle 210 through path 208, which may have a better cellular connection to remote server 200 through path 209. AED unit 100 may additionally or alternatively attempt direct communications with remote server 200 through path 204.

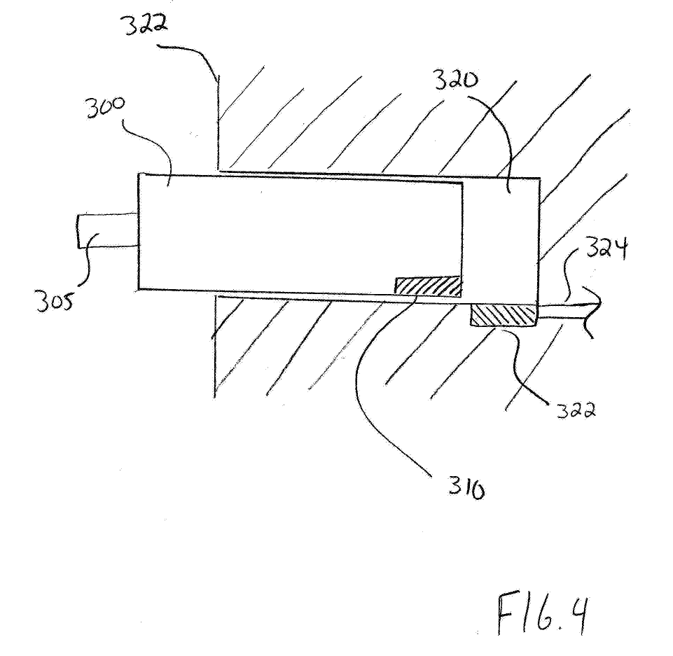

An advantage of an integrated AED unit in accordance with the disclosure is that computerized processes related to treating the afflicted person can be automatically initiated upon activation of the AED unit or removal of the AED unit from the AED chamber fitted to the vehicle or structure. FIG. 4 illustrates an exemplary AED unit installed to a dashboard of a vehicle. AED unit 300 is illustrated including an exemplary handle 305 that normally protrudes from a surface 322 of the dashboard. AED unit 300 fits into a cavity 320 which forms an AED chamber useful for storing and charging the AED unit. AED unit 300 includes electrical contacts 310 configured to electronically mate and connect to mating electrical contacts 322 within cavity 320, such that when AED unit 300 is fully seated within cavity 320, AED unit 300 can recharge and/or communicate data through the connections to other units or modules within the vehicle through electrical harness 324. Electrodes can be connected to and stored near or within AED unit 300. In one exemplary embodiment, handle 305 can rotate 90 degrees to expose the electrodes and associated electrical leads stored within the unit.

According to one embodiment, upon the AED unit 300 being removed from cavity 320, for example, as the electrical connections are broken between contacts 310 and contacts 322, communications between the AED unit 300 and a remote server operated by an emergency responder. Such immediate and automatic communications can be critical in responding to an SCA. Most persons not trained in medical care will panic upon seeing a loved one go into cardiac arrest. By establishing a link to the remote server, a number of actions can be started. For example, an emergency operator can begin talking with the person applying the AED to the person in distress. The operator can tell the person where the electrodes need to be placed, how to position the person in distress, how to react to unexpected circumstances such as convulsions or vomit. The operator can immediately dispatch an ambulance to the location of the incident, with location data being transmitted from the AED unit to the remote server. Telemetry from the electrodes including the presence of a pulse or unusual heart behavior can be monitored by the operator, and refined instructions can be provided to the person applying the electrodes. The actions initiated by the system can be automatic, with automated messages or adjustments to the AED device being applied, or prompts, data, voice communications, etc., can be provided among and between human operators and the person applying the electrodes.

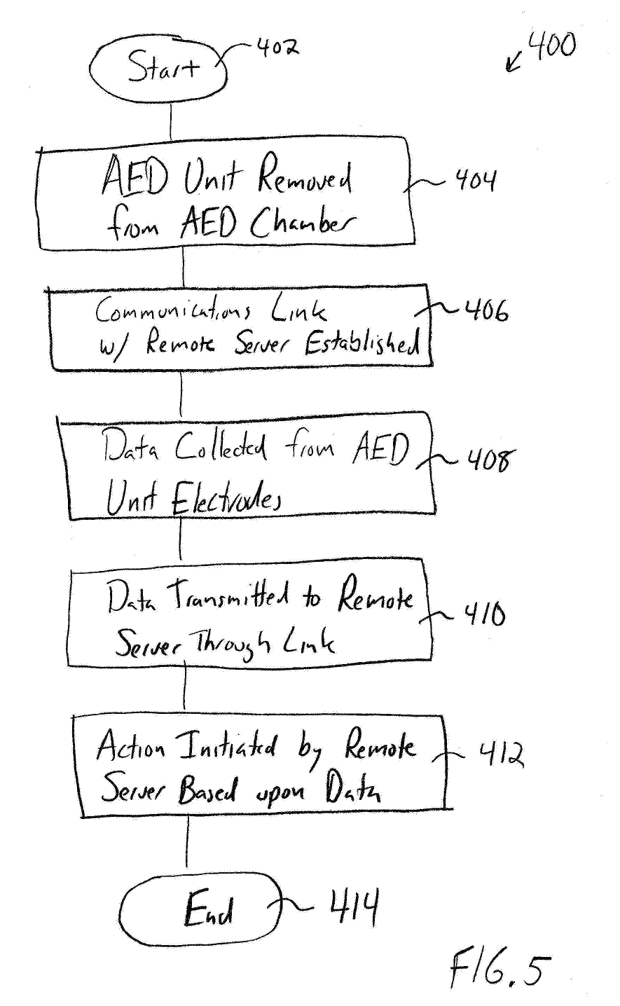

FIG. 5 illustrates an exemplary process to establish a link to a remote server and take action based upon collected data, the process being initiated by an AED unit being removed from an AED chamber. Process 400 starts at step 402. At step 404, an AED unit is removed from an AED chamber. At step 406, a communications link is established between the AED unit and a remote server operated by an emergency responder. At step 408, data is collected from a person in distress through electrodes placed on the person, the electrodes being in communication with and connected to the AED unit. At step 410, the data is transmitted to the remote server through the communications link. At step 412, the action is initiated by the remote server based upon the data transmitted to and received by the remote server. At step 414, the process ends. Process 400 is exemplary, additional or alternative steps can be operated, and the disclosure is not intended to be limited to the particular process steps illustrated in FIG. 5.

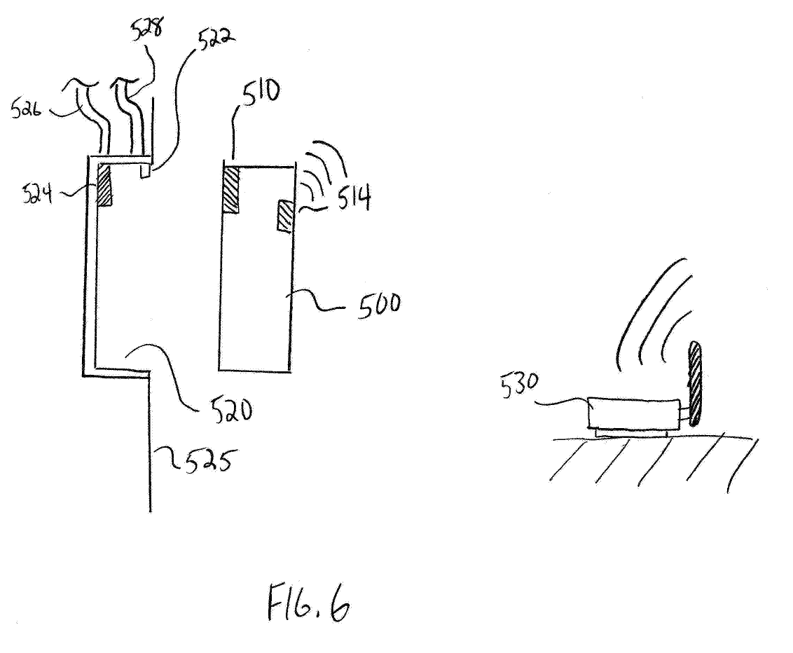

FIG. 6 illustrates an exemplary AED unit stored in a home. AED unit 500 is illustrated including electrical contacts 510 and communications module 514. AED chamber 520 is illustrated installed on a wall surface 525 within a home. AED chamber 520 includes retention latch 522 configured to selectively retain and release AED device 500, electrical contacts 524, power cable 526 providing power to charge AED unit 500, optional data cable 528 providing wired communication from the AED chamber 520 to other systems around the house such as communications router device 530. When AED device 500 is installed to AED chamber 520, electrical connections 510 electrically connected to electrical connections 524. When the AED 500 is removed from AED chamber 520 and the electrical connections are separated, AED device 500 can automatically establish a wireless connection with router device 530, initiating communications and data transmission between the AED device 500 and a remote server, as disclosed herein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus providing improved access to an automated external defibrillator, comprising,
a computerized communication system providing access to a remote server device operated by an emergency responder;
a power system providing power to the automated external defibrillator; and
the automated external defibrillator in electronic communication with the communication system and the power system.

2. The apparatus of claim 1, wherein the automated external defibrillator automatically establishes a communications link to the remote server device when the automated external defibrillator is activated.

3. The apparatus of claim 2, further comprising an automated external defibrillator chamber configured to provide electrical power to the automated external defibrillator;
and wherein activating the automated external defibrillator comprises removing the automated external defibrillator from the automated external defibrillator chamber.

4. The apparatus of claim 1, wherein the access to the remote server device comprises voice communication with a person.

5. The apparatus of claim 1, wherein the access to the remote server device comprises video content played upon a video screen on the automated external defibrillator.

6. The apparatus of claim 1, wherein the access to the remote server device comprises transmitting data from the automated external defibrillator to the remote server device.

7. The apparatus of claim 1, wherein the power system is connected to the automated external defibrillator with a tether.

8. The apparatus of claim 7, wherein the tether comprises a quick release fitting.

9. The apparatus of claim 1, further comprising a cellular/wi-fi communications module enabling the automated external defibrillator to communicate wirelessly.

10. The apparatus of claim 1, wherein the automated external defibrillator is configured to be stored within a mating automated external defibrillator chamber.

11. The apparatus of claim 10, wherein the automated external defibrillator chamber is located within a dash board of a vehicle.

12. The apparatus of claim 10, wherein the automated external defibrillator chamber is located within a console between front seats of a vehicle.

13. The apparatus of claim 10, wherein the automated external defibrillator chamber is located within a seat back of a vehicle.

14. The apparatus of claim 1, wherein the automated external defibrillator comminucates with a heartbeat sensor in a vehicle; and
wherein the the automated external defibrillator activates automatically based upon a problem diagnosed by data from the heartbeat sensor.

15. An apparatus providing improved access to an automated external defibrillator for use within a motor vehicle, comprising,
a computerized communication system providing access to a remote server device operated by an emergency responder;
a vehicle power system providing power to the automated external defibrillator;
the automated external defibrillator in electronic communication with the communication system and the power system; and
a automated external defibrillator chamber configured to store and charge the automated external defibrillator.

16. A computerized process to operate an automated external defibrillator for use within a motor vehicle, comprising:
storing and charging the automated external defibrillator within an automated external defibrillator chamber powered by the motor vehicle;
within a computerized processor within the automated external defibrillator, operating programming configured to:
monitor removal of the automated external defibrillator from the automated external defibrillator chamber; and
automatically activate a computerized communication system within the automated external defibrillator to provide access to a remote server device operated by an emergency responder.
